(19) United States
(12) Patent Application Publication
(10) Pub. No.: US 2024/0006801 A1
(43) Pub. Date: Jan. 4, 2024

(54) JOINT CONNECTOR, CONNECTOR-EQUIPPED WIRE, AND CONNECTOR CASE

(71) Applicants: FURUKAWA ELECTRIC CO., LTD., Tokyo (JP); FURUKAWA AUTOMOTIVE SYSTEMS INC., Inukami-gun (JP)

(72) Inventor: Masahiro OKUMURA, Inukami-gun (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 18/469,612

(22) Filed: Sep. 19, 2023

Related U.S. Application Data
(63) Continuation of application No. PCT/JP2022/009073, filed on Mar. 3, 2022.

(30) Foreign Application Priority Data
Mar. 23, 2021 (JP) 2021-048749

(51) Int. Cl. H01R 13/514

(52) U.S. Cl. CPC H01R 13/514; H01R 12/771

(57) ABSTRACT

Provided is a joint connector formed by stacking connector cases each accommodating a connection terminal. The connector cases each include a main plate part that holds the connection terminal, and a pair of side plate parts perpendicular to the main plate part and parallel to each other. Inner-side surfaces of distal end portions of the respective side plate parts are provided with engaging claws protruding in a direction toward the opposing side plate parts, respectively, and outer-side surfaces of proximal end portions of the respective side plate parts are provided with engaging grooves recessed in a direction toward the opposing side plate parts, respectively. The connector cases are stacked with the engaging claws of one connector case and the engaging grooves of another connector case engaged with each other, respectively.

### TECHNICAL FIELD

The disclosure relates to a joint connector, a connector-equipped wire, and a connector case.

### BACKGROUND ART

In the related art, there have been known joint connectors formed by stacking connector cases accommodating connection terminals (refer to Patent Documents 1 and 2). When such joint connectors are used, the number of terminals can be changed in accordance with the number of wires to be connected.

Incidentally, the joint connectors disclosed in these patent documents include a case holder for accommodating the stacked connector cases. Thus, the number of connector cases to be stacked is limited to the maximum number that can be accommodated in the case holder. Therefore, there has been a demand for a joint connector in which the number of connector cases to be stacked is not limited and the number of terminals can be easily and freely changed.

### CITATION LIST

### Patent Literature

Patent Document 1: JP 2014-112497 A
Patent Document 2: JP 2009-64735 A

### SUMMARY

### Technical Problem

An object of the disclosure is to provide a joint connector in which the number of connector cases to be stacked is not limited and the number of terminals can be easily and freely changed.

### Solution to Problem

The disclosure provides a joint connector formed by stacking connector cases each accommodating a connection terminal, wherein the connector cases each include a main plate part configured to hold the connection terminal, and a pair of side plate parts perpendicular to the main plate part and parallel to each other, an inner-side surface of a distal end portion of each of the pair of side plate parts is provided with an engaging claw protruding in a direction toward the opposing side plate part of the pair of side plate parts or an engaging groove recessed in a direction away from the opposing side plate part, an outer-side surface of a proximal end portion of each of the pair of side plate parts is provided with an engaging groove recessed in the direction toward the opposing side plate part or an engaging claw protruding in the direction away from the opposing side plate part, and the connector cases are stacked with the engaging claws of one of the connector cases and the engaging grooves of another of the connector cases engaged with each other, respectively.

Note that the distal end portion of the side plate part means a distant side end portion of the side plate part distant from the main plate part, and the proximal end portion of the side plate part means a close side end portion of the side plate part close to the main plate part. Further, the inner-side surface means a wall surface on a side of the internal space in which the connection terminal is accommodated, and the outer-side surface means a wall surface on a side opposite to the internal space.

According to the disclosure, the number of connector cases to be stacked is not limited, and the number of terminals can be easily and freely changed.

Specifically, in the joint connector according to the disclosure, the inner-side surface of the distal end portion of each of the side plate parts is provided with the engaging claw protruding in the direction toward the opposing side plate part or the engaging groove recessed in the direction away from the opposing side plate part, and the outer-side surface of the proximal end portion of each of the side plate parts is provided with the engaging groove recessed in the direction toward the opposing side plate part or the engaging claw protruding in the direction away from the opposing side plate part. The connector cases are stacked with the engaging claws of one connector case and the engaging grooves of another connector case engaged with each other, respectively. For this reason, another connector case can be stacked on the connector case that is at the most distal end of the connector cases constituting the joint connector. In addition, the connector cases can be easily stacked by pushing the connector cases to each other with the engaging claws of one connector case and the engaging grooves of another connector case overlapping each other in parallel, respectively. Therefore, the number of connector cases to be stacked is not limited, and the number of terminals can be easily and freely changed.

As an embodiment of the disclosure, the engaging claw or the engaging groove may be provided, at the distal end portion of each of the side plate parts, between one side end face and a middle portion in a direction along the main plate part and the side plate parts, the engaging groove or the engaging claw may be provided, at the proximal end portion of each of the side plate parts, between the one side end face and the middle portion in the direction along the main plate part and the side plate parts, and the connector cases may be stacked with the other side end faces of the engaging claws of one of the connector cases and the other side end faces of the engaging grooves of another of the connector cases being in contact with each other, respectively.

According to the disclosure, in the operation of stacking the connector cases, the connector cases can be stacked without misalignment by aligning the other side end faces of the engaging claws and the other side end faces of the engaging grooves with positions where they come into contact with each other and pushing the connector cases. In addition, since the engaging claw and the engaging groove that are relatively long with respect to a length of one side of the side plate part are provided and a mutually engaging length can be secured, the connector cases can be firmly stacked. Further, since the mutually engaging length can be secured, rattling of the stacked connector cases can be suppressed.

Further, as an embodiment of the disclosure, an extension portion including the engaging claw or the engaging groove may be provided, at the distal end portion of each of the side plate parts, between one side end face and a middle portion in a direction along the main plate part and the side plate parts, a stepped portion including the engaging groove or the engaging claw may be provided, at the proximal end portion of each of the side plate parts, between the one side end face and the middle portion in the direction along the main plate part and the side plate parts, and the connector cases may be stacked with the other side end faces of the extension portions of one of the connector cases and the other side end faces of the stepped portions of another of the connector cases being in contact with each other, respectively.

According to the disclosure, in the operation of stacking the connector cases, the connector cases can be stacked without misalignment by aligning the other side end faces of the extension portions and the other side end faces of the stepped portions with positions where they come into contact with each other and pushing the connector cases. In addition, since the extension portion and the stepped portion that are relatively long with respect to a length of one side of the side plate part are provided and a mutually fitting length can be secured, the connector cases can be firmly stacked. Further, since the mutually engaging length can be secured, rattling of the stacked connector cases can be suppressed.

Further, as an embodiment of the disclosure, an inner-side plate parallel to the side plate parts may be provided at an inner-side surface of the main plate part, an outer-side plate perpendicular to the side plate parts may be provided at an outer-side surface of the main plate part, and the connector cases may be stacked with one side end face of the inner-side plate of one of the connector cases and the other side flat surface of the outer-side plate of another of the connector cases being in contact with each other.

Note that the inner-side surface of the main plate part means a wall surface of the main plate part on a side of the internal space in which the connection terminal is accommodated, and the outer-side surface of the main plate part means a wall surface of the main plate part on a side opposite to the internal space.

According to the disclosure, in the operation of stacking the connector cases, the connector cases can be stacked without misalignment by aligning one side end face of the inner-side plate and the other side flat surface of the outer-side plate with positions where they come into contact with each other and pushing the connector cases. In addition, since the inner-side plate and the outer-side plate come into contact with each other perpendicularly to the engaging claws and the engaging grooves that engage from one side to the other side, rattling of the stacked connector cases can be suppressed. In this regard, to describe specifically, since the engaging claws and the engaging grooves are provided from one side to the other side, rattling may occur in this direction. However, since the inner-side plate and the outer-side plate come into contact with each other along a direction perpendicular to this direction, the inner-side plate and the outer-side plate are restricted from moving toward one side or the other side by each other, so that rattling of the stacked connector cases can be suppressed.

Further, as an embodiment of the disclosure, an inner-side engaging piece protruding toward one side may be provided at one side end face of the inner-side plate, an outer-side engaging piece protruding toward the other side may be provided at the other side flat surface of the outer-side plate, and the connector cases may be stacked with the inner-side engaging piece of one of the connector cases and the outer-side engaging piece of another of the connector cases being engaged with each other.

According to the disclosure, since the inner-side engaging piece of one connector case and the outer-side engaging piece of another connector case are engaged with each other, rattling of the stacked connector cases can be suppressed. In this regard, to describe specifically, since the connector cases are stacked in the stacking direction, rattling may occur in this direction. However, since the inner-side engaging piece and the outer-side engaging piece are engaged with each other along a direction perpendicular to this direction, the inner-side engaging piece and the outer-side engaging piece are restricted from moving toward each other or away from each other by each other, so that rattling of the stacked connector cases can be suppressed.

Further, as an embodiment of the disclosure, a plurality of the connection terminals may be accommodated in each of the connector cases in parallel with a direction from one side to the other side, and the inner-side plate that is non-conductive may be arranged between two adjacent connection terminals of the plurality of connection terminals and along the connection terminals.

According to the disclosure, since the inner-side plate that is non-conductive is arranged between two adjacent connection terminals and along the connection terminals, it is possible to suppress short circuit between adjacent connection terminals. In addition, since the inner-side plate functions as a guide plate in the operation of accommodating the connection terminals in the connector case, the operation is made easy.

Further, as an embodiment of the disclosure, an inner-side surface of each of the side plate parts may be provided with a widened portion protruding in a direction toward the opposing side plate part, and a distal end face of the widened portion may be formed in parallel with and at a constant interval from the engaging claw or the engaging groove.

According to the disclosure, in the operation of stacking the connector cases, the pushed main plate part comes into contact with the distal end faces of the widened portions and is supported along the distal end faces, so that the connector cases can be stacked without inclination.

Further, as an embodiment of the disclosure, an outer-side surface of each of the side plate parts may be provided with a protrusion portion protruding in a direction away from the opposing side plate part, and each of the protrusion portions in the connector cases stacked may constitute a guide passage for a band clamp.

According to the disclosure, misalignment or falling off of the band clamp wound along the protrusion portions can be suppressed. For this reason, the stacked connector cases can be bundled by using the band clamp. In addition, the stacked connector cases can also be fixed to a fixing target by using the band clamp.

Further, as an embodiment of the disclosure, there may be provided a connector-equipped wire including the joint connector according to the disclosure and a wire connected to the connection terminal of each of the connector cases constituting the joint connector.

Note that the joint connector in the disclosure is a concept encompassing all the joint connectors according to the respective inventions described above.

According to the disclosure, even when the specifications of a wire on one side and a wire on the other side connected by the connection terminal are different from each other, an electric cable can be formed in which these are electrically connected. In such an electric cable, loosening and entanglement of the wires can be suppressed and the wires can be bundled in a simplified manner.

Further, as an embodiment of the disclosure, the wire on at least one side may be a flexible flat cable.

Note that the flexible flat cable in the disclosure is a concept encompassing all cables in which conductors arranged in parallel are sandwiched between sheet-like insulators.

According to the disclosure, an electric cable can be formed in which a flexible flat cable and a wire having another specification are electrically connected. In such an electric cable, loosening and entanglement of the wires can be suppressed and the wires can be bundled in a simplified manner.

The disclosure provides a connector case configured to accommodate a connection terminal, the connector case including a main plate part configured to hold the connection terminal, and a pair of side plate parts perpendicular to the main plate part and parallel to each other, wherein an inner-side surface of a distal end portion of each of the pair of side plate parts is provided with an engaging claw protruding in a direction toward an opposing side plate part of the pair of side plate parts or an engaging groove recessed in a direction away from the opposing side plate part, and an outer-side surface of a proximal end portion of each of the pair of side plate parts is provided with an engaging groove recessed in the direction toward the opposing side plate part or an engaging claw protruding in the direction away from the opposing side plate part.

According to the disclosure, the above-described effects can be obtained for the joint connector formed by stacking the connector cases. That is, the number of connector cases to be stacked is not limited, and the number of terminals can be easily and freely changed.

### Advantageous Effects of Invention

According to the disclosure, the number of connector cases to be stacked is not limited and the number of terminals can be easily and freely changed.

### BRIEF DESCRIPTION OF DRAWINGS

FIG. 1 is a perspective view of a connector-equipped wire.

FIG. 2 is a perspective view of a joint connector constituting the connector-equipped wire.

FIG. 3 is a perspective view of a connector case constituting the joint connector.

FIG. 4 is a front view as seen from a direction of an arrow A in FIG. 3.

FIG. 5 is a plan view as seen from a direction of an arrow B in FIG. 3.

FIG. 6 is a side view as seen from a direction of an arrow C in FIG. 3.

FIG. 7 is a cross-sectional view taken along a direction of an arrow X-X in FIG. 6.

FIG. 8 is a view illustrating assembly of the joint connector.

FIG. 9 is a view illustrating assembly of the joint connector.

### DESCRIPTION OF EMBODIMENTS

An embodiment of the disclosure will be described in detail with reference to the drawings.

In the present application, directions of a joint connector 4 are indicated in all figures. Specifically, an arrow F indicates the front side, an arrow B indicates the rear side, an arrow R indicates the right side, and an arrow L indicates the left side. An arrow U indicates the upper side, and an arrow D indicates the lower side.

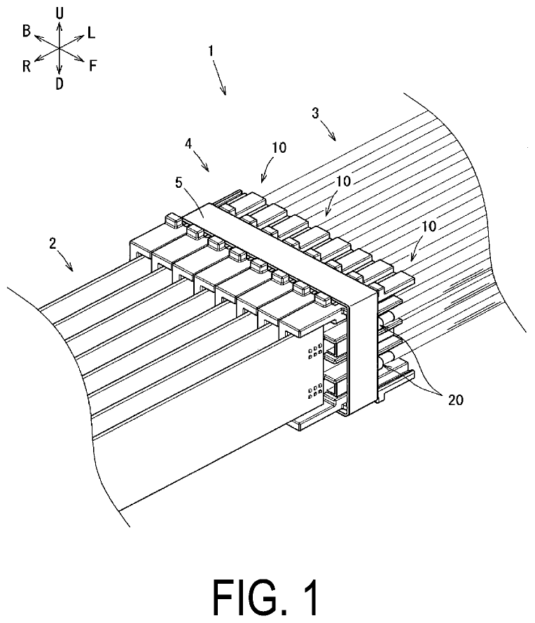

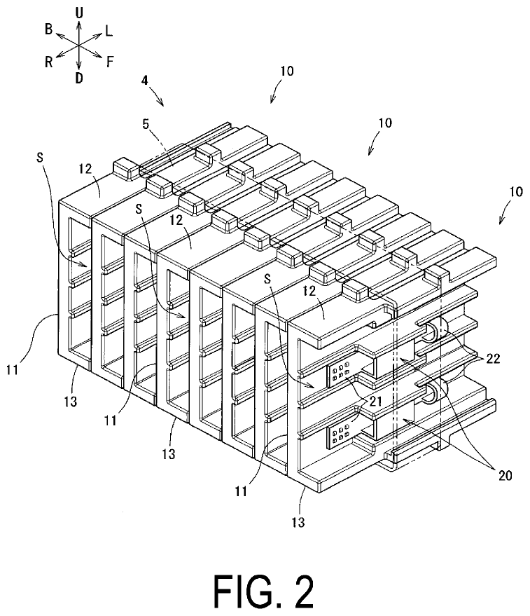

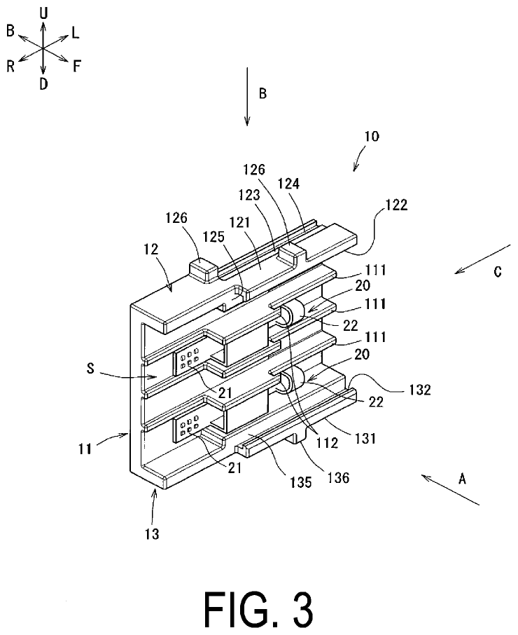

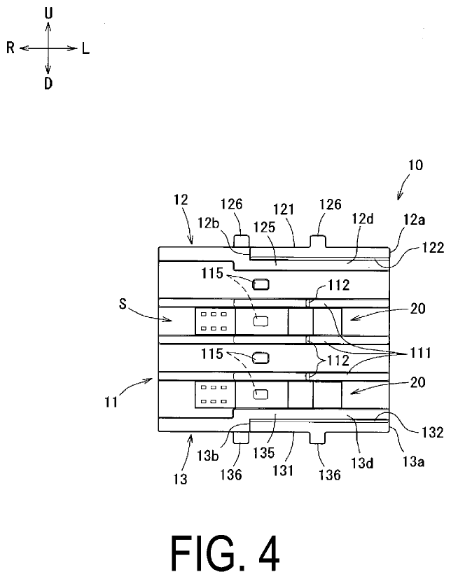

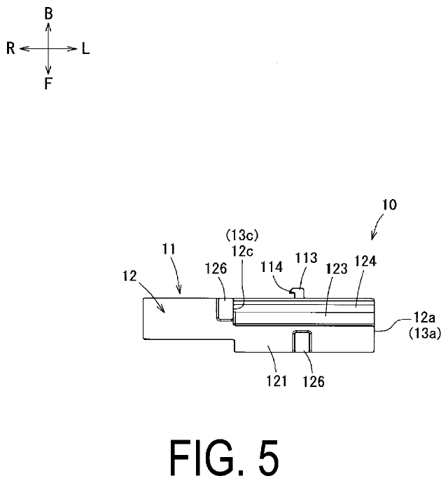

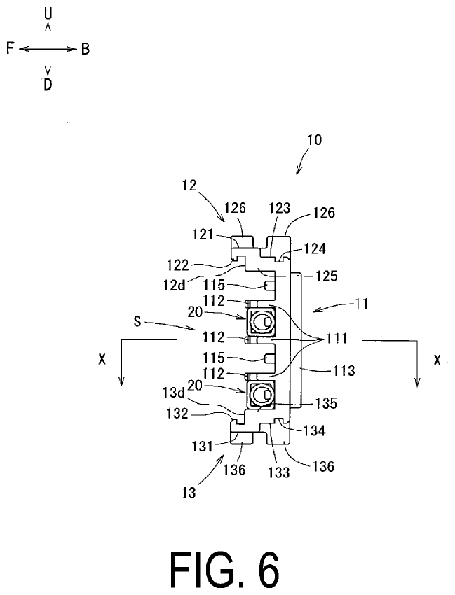

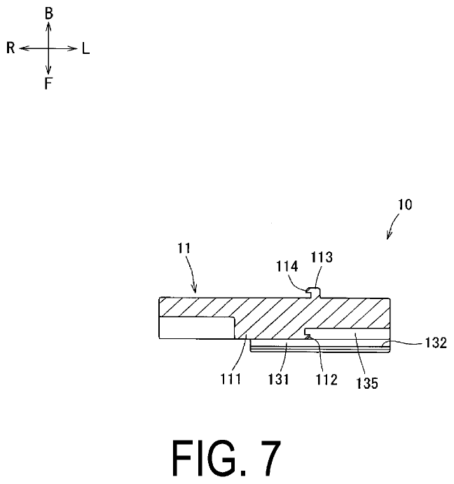

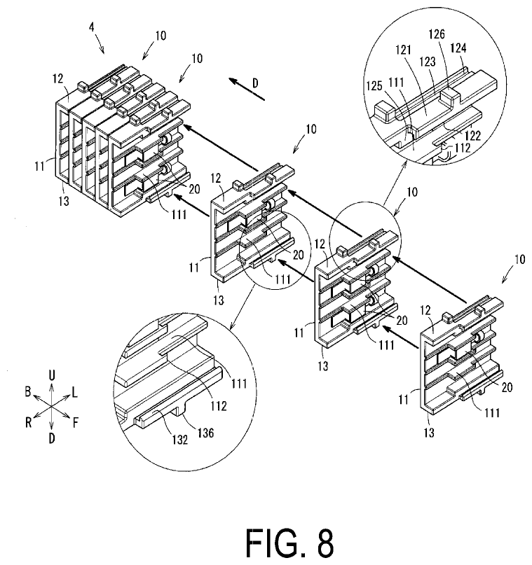

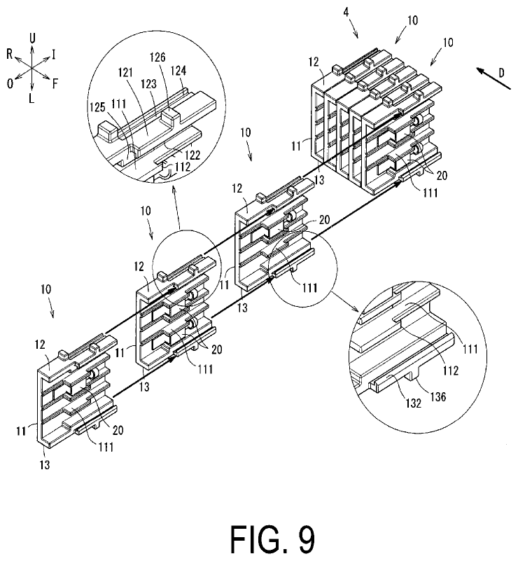

FIG. 1 is a perspective view of a connector-equipped wire 1. FIG. 2 is a perspective view of a joint connector 4 constituting the connector-equipped wire 1. FIG. 3 is a perspective view of a connector case 10 constituting the joint connector 4. FIG. 4 is a front view as seen from a direction of an arrow A in FIG. 3. FIG. 5 is a plan view as seen from a direction of an arrow B in FIG. 3. FIG. 6 is a side view as seen from a direction of an arrow C in FIG. 3. FIG. 7 is a cross-sectional view taken along a direction of an arrow X-X in FIG. 6. FIGS. 8 and 9 are views illustrating assembly of the joint connector 4.

As illustrated in FIG. 1, the connector-equipped wire 1 is constituted by a plurality of flexible flat cables 2 and a plurality of covered cables 3 electrically connected via a joint connector 4. The flexible flat cable 2 and the covered cable 3 are one aspect of a wire.

As illustrated in FIG. 2, the joint connector 4 is formed by stacking connector cases 10. Each connector case 10 is made of a non-conductive synthetic resin and can accommodate a connection terminal 20. Hereinafter, the connector case 10 and the connection terminal 20 will be described in detail.

As illustrated in FIGS. 3 to 7, the connector case 10 includes a main plate part 11, an upper-side plate part 12, and a lower-side plate part 13. In the connector case 10 disclosed in the present application, a space surrounded by the main plate part 11, the upper-side plate part 12, and the lower-side plate part 13 is referred to as an internal space S. In the internal space S, one to four connection terminals 20 can be accommodated.

The main plate part 11 is formed in a substantially plate shape perpendicular to a front-rear direction of the joint connector 4. The main plate part 11 is provided with three inner-side plates 111 protruding toward the front side from an inner-side surface of the main plate part 11. The respective inner-side plates 111 are arranged in parallel with a left-right direction and at predetermined intervals in an upper-lower direction, and are formed to be highest (longest from the main plate part 11) at a middle portion in the left-right direction. An inner-side engaging piece 112 protruding to the left side is provided at a distal end portion of the respective inner-side plates 111.

In addition, the main plate part 11 is provided with one outer-side plate 113 protruding toward the rear side from an outer-side surface of the main plate part 11. The outer-side plate 113 is arranged in parallel with the upper-lower direction on a slightly on the left side of the middle portion in the left-right direction, and is formed to have a constant height (a length from the main plate part 11). An outer-side engaging piece 114 protruding toward the right side is provided at a distal end portion of the outer-side plate 113. Note that only the outer-side plate 113 and the outer-side engaging piece 114 are parallel to the upper-lower direction, and contribute to suppression of flexural deformation in the main plate part 11.

The upper-side plate part 12 is formed in a substantially plate shape perpendicular to the upper-lower direction of the joint connector 4. A distal end portion of the upper-side plate part 12 is provided with an extension portion 121 extending the upper-side plate part 12, between a left-side end face 12a (refer to FIGS. 4 and 5) and the middle portion. The extension portion 121 is formed in a rectangular shape with a constant thickness as seen from above. An engaging claw 122 protruding in a direction toward the opposing lower-side plate part 13 (a direction toward the lower side) is provided at a distal end portion of the extension portion 121. The engaging claw 122 is formed in parallel with the main plate part 11 from a left-side end face of the extension portion 121 (a left-side end face 12a of the upper-side plate part 12) to a right-side end face 12b (refer to FIG. 4).

In addition, a proximal end portion of the upper-side plate part 12 is provided with a stepped portion 123 with an outer-side surface of the upper-side plate part 12 dug down, between the left-side end face 12a and the middle portion. The stepped portion 123 is formed in a rectangular shape with a constant depth as seen from above. At a bottom surface of the stepped portion 123, an engaging groove 124 is provided recessed in a direction toward the opposing lower-side plate part 13 (a direction toward the lower side). The engaging groove 124 is formed in parallel with the main plate part 11 from a left-side end face of the stepped portion 123 (the left-side end face 12a of the upper-side plate part 12) to a right-side end face 12c (refer to FIG. 5). Note that the right-side end face of the engaging groove 124 is equal to the right-side end face 12c of the stepped portion 123.

Further, an inner-side surface of the upper-side plate part 12 is provided with a widened portion 125 protruding in the direction toward the opposing lower-side plate part 13 (a direction toward the lower side) between the left-side end face 12a of the upper-side plate part 12 and the middle portion. The widened portion 125 is formed in a rectangular shape with a constant thickness as seen from the front side. In addition, the widened portion 125 is formed to have a height (a length from the main plate part 11) equal to that of the upper-side plate part 12, and a distal end face 12d of the widened portion 125 (refer to FIGS. 4 and 6) is connected to a distal end face of the upper-side plate part 12 without a step. In this way, the distal end face 12d of the widened portion 125 is formed in parallel with and at a constant interval from the engaging claw 122.

Additionally, the outer-side surface of the upper-side plate part 12 is provided with two protrusion portions 126 protruding in a direction away from the opposing lower-side plate part 13 (a direction toward the upper side). One protrusion portion 126 is provided slightly on the left side of the middle portion in the left-right direction, and the other protrusion portion 126 is provided slightly on the right side of the middle portion in the left-right direction. Therefore, a band clamp 5 can be wound to extend between the protrusion portions 126 (refer to FIGS. 1 and 2). Note that the protrusion portions 126 are formed in a rectangular shape as seen from above, but may also be formed in another shape. In addition, although the protrusion portions 126 are formed in shapes equal to each other, they may also be formed in different shapes.

The lower-side plate part 13 is formed in a substantially plate shape perpendicular to the upper-lower direction of the joint connector 4. A distal end portion of the lower-side plate part 13 is provided with an extension portion 131 extending the lower-side plate part 13, between a left-side end face 13a (refer to FIGS. 4 and 5) and the middle portion. The extension portion 131 is formed in a rectangular shape with a constant thickness as seen from below. An engaging claw 132 protruding in a direction toward the opposing upper-side plate part 12 (a direction toward the upper side) is provided at a distal end portion of the extension portion 131. The engaging claw 132 is formed in parallel with the main plate part 11 from a left-side end face of the extension portion 131 (a left-side end face 13a of the lower-side plate part 13) to a right-side end face 13b (refer to FIG. 4).

In addition, a proximal end portion of the lower-side plate part 13 is provided with a stepped portion 133 with an outer-side surface of the lower-side plate part 13 dug down, between the left-side end face 13a and the middle portion. The stepped portion 133 is formed in a rectangular shape with a constant depth as seen from below. At a bottom surface of the stepped portion 133, an engaging groove 134 is provided recessed in the direction toward the opposing upper-side plate part 12 (the direction toward the upper side). The engaging groove 134 is formed in parallel with the main plate part 11 from a left-side end face of the stepped portion 133 (the left-side end face 13a of the lower-side plate part 13) to a right-side end face 13c (refer to FIG. 5). Note that the right-side end face of the engaging groove 134 is equal to the right-side end face 13c of the stepped portion 133.

Further, an inner-side surface of the lower-side plate part 13 is provided with a widened portion 135 protruding in the direction toward the opposing upper-side plate part 12 (the direction toward the upper side) between the left-side end face 13a of the lower-side plate part 13 and the middle portion. The widened portion 135 is formed in a rectangular shape with a constant thickness as seen from the front side. In addition, the widened portion 135 is formed to have a height (a length from the main plate part 11) equal to that of the lower-side plate part 13, and a distal end face 13d of the widened portion 135 (refer to FIGS. 4 and 6) is connected to a distal end face of the lower-side plate part 13 without a step. In this way, the distal end face 13d of the widened portion 135 is formed in parallel with and at a constant interval from the engaging claw 132.

Additionally, the outer-side surface of the lower-side plate part 13 is provided with two protrusion portions 136 protruding in a direction away from the opposing upper-side plate part 12 (a direction toward the lower side). One protrusion portion 136 is provided slightly on the left side of the middle portion in the left-right direction, and the other protrusion portion 136 is provided slightly on the right side of the middle portion in the left-right direction. Therefore, the band clamp 5 can be wound to extend between the protrusion portions 136 (refer to FIGS. 1 and 2). Note that the protrusion portions 136 are formed in a rectangular shape as seen from below, but may also be formed in another shape. In addition, although the protrusion portions 136 are formed in shapes equal to each other, they may also be formed in different shapes.

With such a configuration, the connector cases are stacked with the engaging claws 122 and 132 of one connector case 10 and the engaging grooves 124 and 134 of another connector case 10 engaged with each other, respectively. At this time, since the engaging claws 122 and 132 and the engaging grooves 124 and 134, which are relatively long with respect to a length of one side of the connector case 10 in the left-right direction, are engaged with each other over their entire lengths, the connector cases 10 can be firmly stacked. In addition, since the extension portions 121 and 131 and the stepped portions 123 and 133, which are relatively long, are fitted to each other over their entire lengths, the connector cases 10 can be firmly stacked.

Further, while the engaging claws 122 and 132 and the engaging grooves 124 and 134 are provided along the left-right direction, the inner-side plates 111 and the outer-side plate 113 come into contact with each other along the upper-lower direction perpendicular to the left-right direction. Therefore, the inner-side plates 111 and the outer-side plate 113 are restricted from moving to the left side or to the right side by each other, so that rattling of the stacked connector cases 10 can be suppressed. Further, while the connector cases 10 are stacked in the stacking direction, the inner-side engaging piece 112 and the outer-side engaging piece 114 are engaged with each other along the upper-lower direction perpendicular to the stacking direction. Therefore, the inner-side engaging piece 112 and the outer-side engaging piece 114 are restricted from moving toward each other or away from each other by each other, so that rattling of the stacked connector cases 10 can be suppressed.

Additionally, in a state where the two connector cases 10 are stacked, the right-side end faces of the engaging claws 122 and 132 of one connector case 10 and the right-side end faces of the engaging grooves 124 and 134 of the other connector case 10 are in contact with each other, respectively. Since the right-side end faces of the engaging claws 122 and 132 are equal to the right-side end faces 12c and 13c of the extension portions 121 and 131, respectively, and the right-side end faces of the engaging grooves 124 and 134 are equal to the right-side end faces 12c and 13c of the stepped portions 123 and 133, respectively, the right-side end faces 12b and 13b of the extension portions 121 and 131 of one connector case 10 and the right-side end faces 12c and 13c of the stepped portions 123 and 133 of the other connector case 10 are also in contact with each other, respectively. Therefore, the connector cases 10 can be stacked without misalignment.

Incidentally, projections 115 are provided between the inner-side plate 111 and the inner-side plate 111 provided at the main plate part 11 and between the inner-side plate 111 and the widened portions 125 and 135, and the connection terminals 20 are held in a state of being fitted to the projections 115, respectively. The connection terminals 20 are held in parallel with the left-right direction. At a location where the connection terminals 20 are held adjacent to each other, the inner-side plate 111 is arranged between two connection terminals 20 along the connection terminals 20.

In addition, the connection terminal 20 is provided with a piercing connection portion 21 at a right-side end portion thereof and a barrel connection portion 22 at a left-side end portion thereof (refer to FIGS. 2 and 3). The piercing connection portion 21 is electrically connected to the flexible flat cable 2 by crimping the flexible flat cable 2 penetrated by piercings (refer to FIG. 1). In addition, the barrel connection portion 22 is electrically connected to the covered cable 3 by crimping the covered cable 3 inserted in a barrel (see FIG. 1).

With such a configuration, the connection terminal 20 can electrically connect the flexible flat cable 2 that is a wire on one side and the covered cable 3 that is a wire on the other side. Note that each of the flexible flat cables 2 includes a plurality of conductors. For this reason, the connector case 10 accommodating a plurality of the connection terminals 20 can electrically connect one flexible flat cable 2 and the plurality of covered cables 3. In addition, the joint connector 4 formed by stacking such connector cases 10 can electrically connect a plurality of flexible flat cables 2 and a plurality of covered cables 3 that are greater in number than that of the flexible flat cables.

Next, an assembly step for the joint connector 4 in which the connector cases 10 accommodating the connection terminals 20 are stacked will be described with reference to FIG. 8. In the following description, a direction from the front side to the rear side of the joint connector 4 is referred to as a stacking direction D.

FIG. 8 illustrates steps of stacking the connector cases 10 by pushing the connector cases 10 to each other with the engaging claws 122 and 132 of one connector case 10 and the engaging grooves 124 and 134 of another connector case 10 overlapping each other in parallel, respectively. In this step, since the engaging claws 122 and 132 and the engaging grooves 124 and 134 are engaged with each other after the engaging claws 122 and 132 climb over end sides of the stepped portions 123 and 133, respectively, a moderate click feeling can be obtained.

In addition, the connector cases 10 can be stacked without misalignment by aligning the right-side end faces of the engaging claws 122 and 132 and the right-side end faces of the engaging grooves 124 and 134 with positions where they come into contact with each other and pushing the connector cases. In this regard, in the connector case 10, since the right-side end faces of the engaging claws 122 and 132 and the right-side end faces of the extension portions 121 and 131 are equal to each other, respectively, and the right-side end faces of the engaging grooves 124 and 134 and the right-side end faces of the stepped portions 123 and 133 are also equal to each other, respectively, the connector cases 10 can be stacked without misalignment by aligning the right-side end faces of the extension portions 121 and 131 and the right-side end faces of the stepped portions 123 and 133 with positions where they come into contact with each other and pushing the connector cases.

As described above, the joint connector 4 is formed by stacking the connector cases 10 accommodating the connection terminals 20. The connector case 10 includes the main plate part 11 that holds the connection terminals 20, and the pair of side plate parts (the upper-side plate part 12 and the lower-side plate part 13) perpendicular to the main plate part 11 and parallel to each other. The inner-side surfaces of the distal end portions of the respective side plate parts 12 and 13 are provided with the engaging claws 122 and 132 protruding in the direction toward the opposing side plate parts 12 and 13, respectively, and the outer-side surfaces of the proximal end portions of the respective side plate parts 12 and 13 are provided with the engaging grooves 124 and 134 recessed in the direction toward the opposing side plate parts 12 and 13, respectively. The connector cases are stacked with the engaging claws 122 and 132 of one connector case 10 and the engaging grooves 124 and 134 of another connector case 10 engaged with each other, respectively.

According to such a joint connector 4, the number of the connector cases 10 to be stacked is not limited, and the number of terminals can be easily and freely changed.

Specifically, in the joint connector 4 according to the disclosure, the inner-side surfaces of the distal end portions of the respective side plate parts 12 and 13 are provided with the engaging claws 122 and 132 protruding in the directions toward the opposing side plate parts 12 and 13, respectively, and the outer-side surfaces of the proximal end portions of the respective side plate parts 12 and 13 are provided with the engaging grooves 124 and 134 recessed in the directions toward the opposing side plate parts 12 and 13, respectively. The connector cases are stacked with the engaging claws 122 and 132 of one connector case 10 and the engaging grooves 124 and 134 of another connector cases 10 engaged with each other, respectively. For this reason, another connector case 10 can be stacked on the connector case 10 that is at the most distal end of the connector cases 10 constituting the joint connector 4. In addition, the connector cases 10 can be easily stacked by pushing the connector cases 10 to each other with the engaging claws 122 and 132 of one connector case 10 and the engaging grooves 124 and 134 of another connector case 10 overlapping each other in parallel, respectively. Therefore, the number of the connector cases 10 to be stacked is not limited, and the number of terminals can be easily and freely changed.

In addition, in the joint connector 4, the engaging claws 122 and 132 are provided, at the distal end portions of the respective side plate parts 12 and 13, between the left-side end faces 12a and 13a and the middle portions in the direction along the main plate part 11 and the side plate parts 12 and 13, respectively, and the engaging grooves 124 and 134 are provided, at the proximal end portions of the respective side plate parts 12 and 13, between the left-side end faces 12a and 13a and the middle portions in the direction along the main plate part 11 and the side plate parts 12 and 13, respectively. The connector cases 10 are stacked with the right-side end faces 12b and 13b of the engaging claws 122 and 132 of one connector case 10 and the right-side end faces 12c and 13c of the engaging grooves 124 and 134 of another connector case 10 being in contact with each other, respectively.

According to the joint connector 4, in the operation of stacking the connector cases 10, the connector cases 10 can be stacked without misalignment by aligning the right-side end faces 12b and 13b of the engaging claws 122 and 132 and the right-side end faces 12c and 13c of the engaging grooves 124 and 134 with positions where they come into contact with each other and pushing the connector cases. In addition, since the engaging claws 122 and 132 and the engaging grooves 124 and 134, which are relatively long with respect to a length of one side of each of the side plate parts 12 and 13, are provided and mutually engaging lengths can be secured, the connector cases 10 can be firmly stacked. Further, since the mutually engaging lengths can be secured, rattling of the stacked connector cases 10 can be suppressed.

In addition, in the joint connector 4, the extension portions 121 and 131 including the engaging claws 122 and 132 are provided, at the distal end portions of the respective side plate parts 12 and 13, between the left-side end faces 12a and 13a and the middle portions in the direction along the main plate part 11 and the side plate parts 12 and 13, respectively, and the stepped portions 123 and 133 including the engaging grooves 124 and 134 are provided, at the proximal end portions of the respective side plate parts 12 and 13, between the left-side end faces 12a and 13a and the middle portions in the direction along the main plate part 11 and the side plate parts 12 and 13, respectively. The connector cases 10 are stacked with the right-side end faces 12b and 13b of the extension portions 121 and 131 of one connector case 10 and the right-side end faces 12c and 13c of the stepped portions 123 and 133 of another connector case 10 being in contact with each other, respectively.

According to the joint connector 4, in the operation of stacking the connector cases 10, the connector cases 10 can be stacked without misalignment by aligning the right-side end faces 12b and 13b of the extension portions 121 and 131 and the right-side end faces 12c and 13c of the stepped portions 123 and 133 with positions where they come into contact with each other and pushing the connector cases. In addition, since the extension portions 121 and 131 and the stepped portions 123 and 133, which are relatively long with respect to the length of one side of each of the side plate parts 12 and 13, are provided and mutually fitting lengths can be secured, the connector cases 10 can be firmly stacked. Further, since the mutually fitting lengths can be secured, rattling of the stacked connector cases 10 can be suppressed.

In addition, in the joint connector 4, the inner-side plates 111 parallel to the side plate parts 12 and 13 are provided at the inner-side surface of the main plate part 11, and the outer-side plate 113 perpendicular to the side plate parts 12 and 13 is provided at the outer-side surface of the main plate part 11. The connector cases 10 are stacked with the left-side end faces of the inner-side plates 111 of one connector case 10 and the right-side flat surface of the outer-side plate 113 of another connector case 10 being in contact with each other.

According to the joint connector 4, in the operation of stacking the connector cases 10, the connector cases 10 can be stacked without misalignment by aligning the left-side end faces of the inner-side plates 111 and the right-side flat surface of the outer-side plate 113 with positions where they come into contact with each other and pushing the connector cases. In addition, since the inner-side plates 111 and the outer-side plate 113 come into contact with each other perpendicularly to the engaging claws 122 and 132 and the engaging grooves 124 and 134 that engage from the left side to the right side, rattling of the stacked connector cases 10 can be suppressed. In this regard, to describe specifically, since the engaging claws 122 and 132 and the engaging grooves 124 and 134 are provided along the left-right direction, rattling may occur in the left-right direction. However, since the inner-side plates 111 and the outer-side plate 113 come into contact with each other along the upper-lower direction perpendicular to the left-right direction, the inner-side plates 111 and the outer-side plate 113 are restricted from moving to the left side or to the right side by each other, so that rattling of the stacked connector cases 10 can be suppressed.

In addition, in the joint connector 4, the inner-side engaging pieces 112 protruding to the left side are provided at the left-side end faces of the inner-side plates 111, and the outer-side engaging piece 114 protruding to the right side is provided at the right-side flat surface of the outer-side plate 113. The connector cases 10 are stacked with the inner-side engaging piece 112 of one connector case 10 and the outer-side engaging piece 114 of another connector cases 10 being engaged with each other.

According to the joint connector 4, since the inner-side engaging piece 112 of one connector case 10 and the outer-side engaging piece 114 of another connector case 10 are engaged with each other, rattling of the stacked connector cases 10 can be suppressed. In this regard, to describe specifically, since the connector cases 10 are stacked in the stacking direction D, rattling may occur in the stacking direction D. However, since the inner-side engaging piece 112 and the outer-side engaging piece 114 are engaged with each other along the upper-lower direction perpendicular to the stacking direction D, the inner-side engaging piece 112 and the outer-side engaging piece 114 are restricted from moving toward each other or away from each other by each other, so that rattling of the stacked connector cases 10 can be suppressed.

In addition, in the joint connector 4, the plurality of connection terminals 20 are accommodated in the connector case 10 in parallel with the direction from the left side to the right side. The inner-side plate 111 that is non-conductive is arranged between two adjacent connection terminals 20 along the connection terminals 20.

According to the joint connector 4, since the inner-side plate 111 that is non-conductive is arranged between two adjacent connection terminals 20 along the connection terminals 20, it is possible to suppress short circuit between adjacent connection terminals 20. In addition, since the inner-side plate 111 functions as a guide plate in the operation of accommodating the connection terminals 20 in the connector case 10, the operation is made easy.

Further, in the joint connector 4, the inner-side surfaces of the respective side plate parts 12 and 13 are provided with the widened portions 125 and 135 protruding in the direction toward the opposing side plate parts 12 and 13, respectively. The distal end faces 12d and 13d of the widened portions 125 and 135 are formed in parallel with and at a constant interval from the engaging claws 122 and 132.

According to the joint connector 4, in the operation of stacking the connector cases 10, the pushed main plate part 11 comes into contact with the distal end faces 12d and 13d of the widened portions 125 and 135 and is supported along the distal end faces 12d and 13d, so that the connector cases 10 can be stacked without inclination.

Further, in the joint connector 4, the outer-side surfaces of the respective side plate parts 12 and 13 are provided with the protrusion portions 126 and 136 protruding in the direction away from the opposing side plate parts 12 and 13, respectively. The respective protrusion portions 126 and 136 of the stacked connector cases 10 form a guide passage for the band clamp 5.

According to the joint connector 4, misalignment or falling off of the band clamp 5 wound along the protrusion portions 126 and 136 can be suppressed. For this reason, the stacked connector cases 10 can be bundled by using the band clamp 5. In addition, the stacked connector cases 10 can also be fixed to a fixing target by using the band clamp 5.

In addition, the disclosure relates to the connector-equipped wire 1 including the joint connector 4 according to the disclosure and a wire (the flexible flat cable 2 and the covered cable 3) connected to the connection terminal 20 of the connector case 10 constituting the joint connector 4.

Note that the joint connector 4 in the disclosure is a concept encompassing all the joint connectors 4 according to the respective inventions described above.

According to the connector-equipped wire 1, even when the specifications of a wire on one side (flexible flat cable 2) and a wire on the other side (covered cable 3) connected by the connection terminal 20 are different from each other, an electric cable can be formed in which these wires are electrically connected. In such an electric cable, loosening and entanglement of the wires 2 and 3 can be suppressed and the wires 2 and 3 can be bundled in a simplified manner.

In addition, in the connector-equipped wire 1, the wire on at least one side is the flexible flat cable 2.

Note that the flexible flat cable 2 in the disclosure is a concept encompassing all cables in which conductors arranged in parallel are sandwiched between sheet-like insulators.

According to the connector-equipped wire 1, an electric cable can be formed in which the flexible flat cable 2 and a wire (covered cable 3) having another specification are electrically connected. In such an electric cable, loosening and entanglement of the wires 2 and 3 can be suppressed and the wires 2 and 3 can be bundled in a simplified manner.

Further, the connector case 10 for accommodating the connection terminal 20 includes the main plate part 11 that holds the connection terminals 20 and the pair of side plate parts (the upper-side plate part 12 and the lower-side plate part 13) perpendicular to the main plate part 11 and parallel to each other, the inner-side surfaces of the distal end portions of the respective side plate parts 12 and 13 are provided with the engaging claws 122 and 132 protruding in the direction toward the opposing side plate parts 12 and 13, respectively, and the outer-side surfaces of the proximal end portions of the respective side plate parts 12 and 13 are provided with the engaging grooves 124 and 134 recessed in the direction toward the opposing side plate parts 12 and 13, respectively.

According to the connector case 10, the above-described effects can be obtained for the joint connector 4 formed by stacking the connector cases 10. That is, the number of the connector cases 10 to be stacked is not limited, and the number of terminals can be easily and freely changed.

In correspondence between the configuration of the disclosure and the above-described embodiment, the connector-equipped wire of the disclosure corresponds to the connector-equipped wire 1, and similarly, the wire corresponds to the flexible flat cable 2 and the covered cable 3, the joint connector corresponds to the joint connector 4, the connector case corresponds to the connector case 10, the main plate part corresponds to the main plate part 11, the side plate parts correspond to the upper-side plate part 12 and the lower-side plate part 13, the inner-side plate corresponds to the inner-side plate 111, the inner-side engaging piece corresponds to the inner-side engaging piece 112, the outer-side plate corresponds to the outer-side plate 113, the outer-side engaging piece corresponds to the outer-side engaging piece 114, the extension portion corresponds to the extension portion 121 and the extension portion 131, the engaging claw corresponds to the engaging claw 122 and the engaging claw 132, the stepped portion corresponds to the stepped portion 123 and the stepped portion 133, the engaging groove corresponds to the engaging groove 124 and the engaging groove 134, the widened portion corresponds to the widened portion 125 and the widened portion 135, the protrusion portion corresponds to the protrusion portion 126 and the protrusion portion 136, the connection terminal corresponds to the connection terminal 20, and the stacking direction corresponds to the stacking direction D. However, the disclosure is not limited to only the configuration of the above-described embodiment, and many embodiments can be obtained.

For example, in the joint connector 4 disclosed in the present application, the wire on one side to be electrically connected by the connection terminal 20 is the flexible flat cable 2, and the wire on the other side is the covered cable 3 having a circular cross-sectional shape. However, the flexible flat cables 2 may be connected on both sides by changing the connection terminal 20. Alternatively, the covered cables 3 may be connected on both sides.

Furthermore, as illustrated in FIG. 9, in the joint connector 4 disclosed in the present application, the connector cases 10 can be stacked by fitting to each other and sliding the engaging claws 122 and 132 of one connector case 10 and the engaging grooves 124 and 134 of another connector case 10 from a side (in the left-right direction). In this step, after the outer-side plate 113 climbs over long sides of the inner-side plates 111, the left-side end faces of the inner-side plates 111 and the right-side flat surface of the outer-side plate 113 come into contact with each other and the inner-side engaging pieces 112 and the outer-side engaging piece 114 are engaged with each other, so that a moderate click feeling can be obtained.

Further, since the right-side end faces of the engaging claws 122 and 132 and the right-side end faces of the engaging grooves 124 and 134 come into contact with each other and stop at appropriate positions, respectively, the connector cases 10 can be stacked without misalignment. In this regard, in the connector case 10, since the right-side end faces of the engaging claws 122 and 132 and the right-side end faces of the extension portions 121 and 131 are equal to each other, respectively, and the right-side end faces of the engaging grooves 124 and 134 and the right-side end faces of the stepped portions 123 and 133 are also equal to each other, respectively, the right-side end faces of 10 the extension portions 121 and 131 and the right-side end faces of the stepped portions 123 and 133 come into contact with each other and stop at appropriate positions, respectively, so that the connector cases 10 can be stacked without misalignment.

### REFERENCE SIGNS LIST

1: Connector-equipped wire
2: Flexible flat cable
3: Covered cable
4: Joint connector
10: Connector case
11: Main plate part
12: Upper-side plate part
13: Lower-side plate part
111: Inner-side plate
112: Inner-side engaging piece
113: Outer-side plate
114: Outer-side engaging piece
121: Extension portion
122: Engaging claw
123: Stepped portion
124: Engaging groove
125: Widened portion
126: Protrusion portion
131: Extension portion
132: Engaging claw
133: Stepped portion
134: Engaging groove
135: Widened portion
136: Protrusion portion
20: Connection terminal
D: Stacking direction

1. A joint connector formed by stacking connector cases each accommodating a connection terminal, wherein
the connector cases each comprise:
a main plate part configured to hold the connection terminal, and
a pair of side plate parts perpendicular to the main plate part and parallel to each other,
an inner-side surface of a distal end portion of each of the pair of side plate parts is provided with an engaging claw protruding in a direction toward an opposing side plate part of the pair of side plate parts or an engaging groove recessed in a direction away from the opposing side plate part,
an outer-side surface of a proximal end portion of each of the pair of side plate parts is provided with an engaging groove recessed in a direction toward the opposing side plate part or an engaging claw protruding in a direction away from the opposing side plate part, and
the connector cases are stacked with the engaging claws of one of the connector cases and the engaging grooves of another of the connector cases engaged with each other, respectively.

2. The joint connector according to claim 1, wherein
the engaging claw or the engaging groove is provided, at the distal end portion of each of the side plate parts, between one side end face and a middle portion in a direction along the main plate part and the side plate parts,
the engaging groove or the engaging claw is provided, at the proximal end portion of each of the side plate parts, between the one side end face and the middle portion in the direction along the main plate part and the side plate parts, and
the connector cases are stacked with the other side end faces of the engaging claws of one of the connector cases and the other side end faces of the engaging grooves of another of the connector cases being in contact with each other, respectively.

3. The joint connector according to claim 1, wherein
an extension portion comprising the engaging claw or the engaging groove is provided, at the distal end portion of each of the side plate parts, between one side end face and a middle portion in a direction along the main plate part and the side plate parts,
a stepped portion comprising the engaging groove or the engaging claw is provided, at the proximal end portion of each of the side plate parts, between the one side end face and the middle portion in the direction along the main plate part and the side plate parts, and
the connector cases are stacked with the other side end faces of the extension portions of one of the connector cases and the other side end faces of the stepped portions of another of the connector cases being in contact with each other, respectively.

4. The joint connector according to claim 1, wherein
an inner-side plate parallel to the side plate parts is provided at an inner-side surface of the main plate part,
an outer-side plate perpendicular to the side plate parts is provided at an outer-side surface of the main plate part, and
the connector cases are stacked with one side end face of the inner-side plate of one of the connector cases and the other side flat surface of the outer-side plate of another of the connector cases being in contact with each other.

5. The joint connector according to claim 4, wherein
an inner-side engaging piece protruding toward one side is provided at the one side end face of the inner-side plate,
an outer-side engaging piece protruding toward the other side is provided at the other side flat surface of the outer-side plate, and
the connector cases are stacked with the inner-side engaging piece of one of the connector cases and the outer-side engaging piece of another of the connector cases engaged with each other.

6. The joint connector according to claim 4, wherein
a plurality of the connection terminals are accommodated in each of the connector cases in parallel with a direction from one side to the other side, and
the inner-side plate that is non-conductive is arranged between two adjacent connection terminals of the plurality of connection terminals and along the connection terminals.

7. The joint connector according to claim 1, wherein
an inner-side surface of each of the side plate parts is provided with a widened portion protruding in the direction toward the opposing side plate part, and
a distal end face of the widened portion is opposed to the engaging claw or the engaging groove with the distal end face of the widened portion being in parallel with and at a constant interval from the engaging claw or the engaging groove.

8. The joint connector according to claim 1, wherein
an outer-side surface of each of the side plate parts is provided with a protrusion portion protruding in the direction away from the opposing side plate part, and
each of the protrusion portions in the connector cases stacked constitutes a guide passage for a band clamp.

9. A connector-equipped wire comprising:
the joint connector according to claim 1; and
a wire connected to the connection terminal of each of the connector cases constituting the joint connector.

10. The connector-equipped wire according to claim 9, wherein
the wire on at least one side is a flexible flat cable.

11. A connector case configured to accommodate a connection terminal, the connector case comprising:
a main plate part configured to hold the connection terminal; and
a pair of side plate parts perpendicular to the main plate part and parallel to each other, wherein
an inner-side surface of a distal end portion of each of the pair of side plate parts is provided with an engaging claw protruding in a direction toward an opposing side plate part of the pair of side plate parts or an engaging groove recessed in a direction away from the opposing side plate part, and
an outer-side surface of a proximal end portion of each of the pair of side plate parts is provided with an engaging groove recessed in the direction toward the opposing side plate part or an engaging claw protruding in the direction away from the opposing side plate part.
